(19) United States
(12) Patent Application Publication
(10) Pub. No.: US 2006/0062818 A1
(43) Pub. Date: Mar. 23, 2006

(54) Method for removal of insects and the prevention of insect infestation in transit

(76) Inventors: Roland N. Walker, Idaho Falls, ID (US); Carl B. Taylor, Idaho Falls, ID (US); Lynn F. Johnson, American Falls, ID (US); Phil W. Simpson, Idaho Falls, ID (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/228,928

(22) Filed: Sep. 16, 2005

Related U.S. Application Data
(60) Provisional application No. 60/610,839, filed on Sep. 17, 2004.

(51) Int. Cl. A01N 59/00; A01N 25/00

(52) U.S. Cl. 424/405; 424/600

(57) ABSTRACT

A transportation system having ozone generators, fans, and a flexible skirt to create a concentrated area of ozone within the containment system to drive insects from the container and to discourage insects from entering the container during transport.

### RELATED APPLICATIONS

This application claims priority to U.S. Provisional Patent Application Ser. No. 60/610,839, filed Sep. 17, 2004, entitled “Method for Removal of Insects and the Prevention of Insect Infestation in Transit.”

### BACKGROUND

1. Field of the Invention

The present invention relates to transportation systems. More specifically, the present invention relates to a transportation system for discouraging insects from entering and driving insects from the transportation system's container.

2. Background

Crops are often transported great distances after harvest before consumption or use. One of the greatest challenges in transporting healthy crops is insect infestation. Some insects are transitory and may alight on the crop just prior to harvesting. These insects then accompany the harvest into the storage facilities for the particular crop and may then consume or otherwise damage the crop. While many crops are free from insects when harvested, they later become exposed to infestations during storage and transport. This in transit insect exposure can also lead to significant crop damage.

Thus, it appears there is a need for a method for removal of insects and the prevention of insect infestation in the transit of crops.

### SUMMARY AND OBJECTS OF THE INVENTION

It is an object of some embodiments of the present invention to provide a system for the injection of ozone gas in sufficient concentrations to drive insects from a harvested crop prior to storage of that crop or transportation of that crop. The present invention comprises a series of fans and ozone generators located in or on the transportation vehicle such as a railroad car, ship or truck wherein the ozone generators produce a concentration of ozone at a level above 100 parts per million (ppm) and preferably in the 300 to 500 ppm level and fans which drive the ozone toward the inlets and outlets of the storage or transportation container. Insects can sense the presence of ozone and will generally not enter an area where there is a high concentration of ozone. Driving the ozone toward- the inlets and outlets at a very gentle pressure, significant ozone will not leave the containment area but will be present at a level which will dissuade insects from entering into the container. Vapor recovery systems may be placed at the inlet to scavenge any ozone which leaves the containment area.

While the methods and processes of the present invention have proven to be particularly useful in the area of crop transportation, those skilled in the art can appreciate that the methods and processes can be used in a variety of different applications and in a variety of different areas of manufacture to yield improved crop preservation results.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a depiction of a cargo ship in which is installed an ozination system for eradicating a cargo of insect infestation and discouraging future infestations.

### DETAILED DESCRIPTION OF THE PREFERRED EMBODIMENTS

The present invention relates to transportation systems. More specifically, the present invention relates to a transportation system for discouraging insects from entering and driving insects from the transportation system's container.

In the disclosure and in the claims the term “transport” shall refer to any mode of transportation capable of transporting perishables and includes, but is not limited to, vessels, trucks and rail cars.

In the disclosure and in the claims the term “insects” shall refer to any insects, molds, bacteria, dust and any bio-forms that may harm perishable items such as crops.

In the disclosure and in the claims the term “container” or “containment area” shall refer to any defined area within a transport that can house perishables, such as crops.

In the disclosure and in the claims the term “crop” shall refer to any perishable item housed or stored in a containment area.

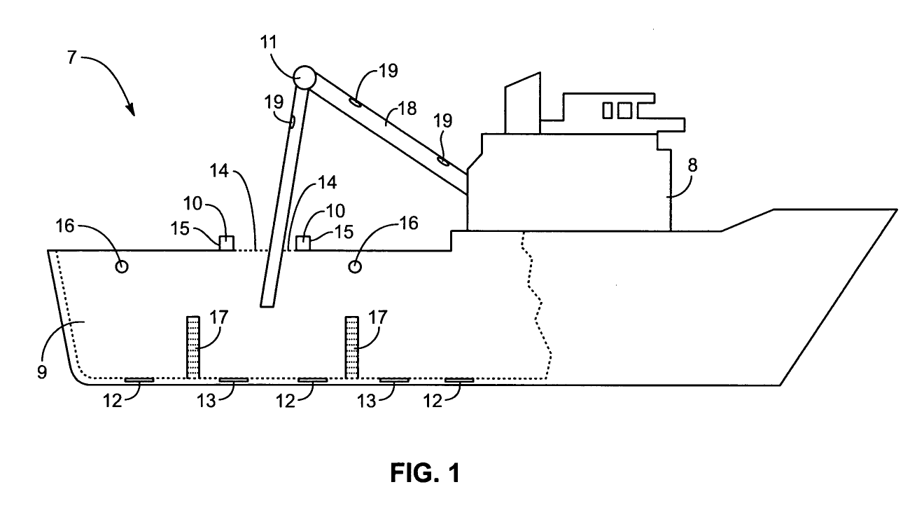

FIG. 1 depicts a representative transportation system 7 where a cargo ship 8 is depicted which has a containment area 9 for storing and transporting crops (not shown) such as grain, potatoes, and other transportable agricultural products. Hatches 10 are shown open so that a grain loading system 11 can be used to transport grain into the containment area 9 of the ship. Prior to the beginning of the loading of the grain, ozone generators 12 and fans 13 are activated to raise the level of ozone within the containment area 9 to above 100 ppm, and preferably in the 300 to 500 ppm range. A flexible skirt 14 seals the containment area 9 around the grain loading system 11 to prevent significant amounts of ozone from leaving the containment area 9. Flexible skirt 14 is devised to allow some airflow and to allow insects the opportunity to leave the containment area 9. Excess ozone is scattered by a scavenging system 15 to prevent a large amount of ozone from leaving the containment area 9. The pressure differential between the inside of the containment area 9 and the outside of the containment area 9 is meant to be maintained at between 0.5 and 2.0 pounds per square inch (psi).

It will be appreciated that although cargo ship 8 is used to illustrate the system 7, the same system will be easily installed in trucks, rail cars and any other mode of transporting perishables. As prolonged exposure to this system 7 could result in the destruction of the insects, molds, bacteria, dust and other unwanted bio-forms, it is the intent of the present invention to not only provide for the long term destruction of these bio-forms, but also to discourage those bio-forms which are capable of leaving the containment area 9, such as insects, from entering the containment area 9 or from staying in the containment area 9 after they have been carried in by the crop to be transported.

In addition, if the transportation system 7 requires that the crop remain in the containment area 9 for long periods of time (for example over thirty days), then the system 7 can be activated en route to encourage any insects which have hatched to leave the containment area 9.

A monitor 16 measures the level of ozone in the containment area 9 and is connected electronically to the ozone generators 12 to maintain a sufficient concentration of ozone.

It will also be appreciated that the above disclosed system could also be used for crops which are not stacked but which are instead placed on trays to prevent crushing, e.g., grapes, strawberries, and other fruit etc. can also be treated in the same manner. It is important that the ozone gas be allowed to flow around the crop, and so in some embodiments, and depending on the configuration of the containment area 9, it may be necessary to employ hollow tubes with holes formed on the outer surface thereof to allow penetration of the gas into more dense or deeply buried crops. An example of these penetration devices are shown at 17.

In some embodiments, the auger or conveyor system 18 which transports the product to the containment area 9 may also be pressurized by ozone and have intermittent openings 19 for the egress of insects.

Thus, as discussed herein, the implementations of the present invention embrace a transportation system for discouraging insects from entering and driving insects from the transportation system's container.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method for encouraging the egress of insects from a crop on a transport, the method comprising the steps of:
a) pressurizing a containment area with a concentration of ozone gas of above 100 ppm;
b) circulating the ozone gas so that the gas will come in contact with the crop;
c) providing a scavenging system to remove excess ozone and prevent the ozone from entering an atmosphere;
d) providing a skirt around an auger to reduce the amount of ozone which leaves the pressurized containment area, while leaving sufficient opening for the insects to exit; and
e) maintaining the pressurized system for a period of time after the loading is complete to allow insects to flee the ozonated area after removal of the loading auger.

2. A method as described in claim 1, wherein the preferential difference between the inside of the container and the atmosphere is approximately in the range from between 0.5 and 2.0 psi.

3. A method as described in claim 1, wherein the pressure is reduced after the removal of the auger to atmospheric pressure, the concentration of ozone being maintained at at least 100 ppm.

4. A method as described in claim 1, wherein the ozone gas is circulated with fans.

5. A method as described in claim 1, wherein the auger is a conveyor system.

6. A system for dissuading insects from entering a container and from encouraging insects to leave the container, the system comprising:
a) an ozone generator;
b) a pressurization fan;
c) ozone monitors connected to the ozone generators to maintain a concentration of ozone within the container; and
d) a flexible skirt to surround the equipment loading crop into the container while still permitting egress with insects.

7. The system of claim 6, wherein the concentration of ozone is maintained at least at 100 ppm.

8. The system of claim 6, wherein the preferential difference between the inside of the container and an atmosphere is approximately in the range from between 0.5 and 2.0 psi.

9. The system of claim 6, further comprising a scavenging system to remove excess ozone and prevent that ozone from entering the atmosphere.
